(19) United States
(12) Patent Application Publication
(10) Pub. No.: US 2004/0257044 A1
(43) Pub. Date: Dec. 23, 2004

(54) Backup battery and discharging control apparatus therefor

(75) Inventor: Takashi Nagaoka, Ikoma-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/861,854

(22) Filed: Jun. 4, 2004

(30) Foreign Application Priority Data
Jun. 6, 2003 (JP) 2003-161805

(51) Int. Cl. H02J 7/00

(52) U.S. Cl. 320/132

(57) ABSTRACT

A discharging control apparatus for a backup battery includes a discharging switch for turning on/off discharging to a load, a state detection portion for detecting a state of the secondary battery, a remaining amount calculation portion for calculating a remaining capacity of the secondary battery based on data detected by the state detection portion, a discharging capacity setting portion for storing an estimated value of a discharging capacity during backup, a subtraction portion for subtracting the discharging capacity estimated value from the remaining capacity calculated by the remaining amount calculation portion, a remaining capacity setting portion for storing a remaining capacity lower limit value of the secondary battery at a completion of discharging, and a capacity comparison portion for comparing a subtraction result of the subtraction portion with the remaining capacity lower limit value, and outputting a discharging suspension signal for turning off the discharging switch, in the case where the remaining capacity lower limit value is equal to or larger than the subtraction result.

### BACKGROUND OF THE INVENTION

1. Field of the Invention

The present invention relates to a battery for driving electronic equipment, and in particular, to a backup battery used when a commercial power source is suspended and a discharging control apparatus thereof.

2. Description of the Related Art

Recently, a backup battery is used widely as a power source backup when a commercial power source is suspended, in electronic equipment such as an information processing apparatus or emergency lighting.

One important aspect of the backup battery is the prolonging of battery life. In order to prolong battery life, a charging and discharging apparatus also is improved in addition to the prolonging of a battery. When a backup battery is over-discharged during discharging, the prolonging of battery life is inhibited. Therefore, a method for suspending discharging of a battery in an appropriate state so as not to allow the battery to be over-discharged has been studied conventionally.

In order to suspend discharging, for example, as shown in FIG. 4, the following method generally is performed in a conventional discharging control apparatus, and there is an example in which the following principle is used for controlling charging (e.g., see pages 2-3 of JP10(1998)-69925A). The conventional discharging control apparatus detects a discharging voltage of a combined battery 81 by a voltage detection portion 84, and compares the discharging voltage with a voltage value (e.g., 1.0 V per cell in the case of a nickel-hydrogen storage battery, etc.) previously set in a voltage setting portion 92 with a comparison portion 86. Then, when the discharging voltage reaches the set voltage value, the discharging control apparatus outputs a discharging suspension signal to turn off a discharging switch 83, thereby suspending the discharging from the combined battery 81 to a load 82.

However, an optimum value of the voltage value to be set in the voltage setting portion 92 is varied depending upon an environmental temperature and a discharging current value. Thus, in the case of the above-mentioned conventional method, the set voltage value needs to be corrected in accordance with a temperature and a discharging current value of the combined battery 81. Therefore, it is necessary to provide a temperature detection portion 85 for detecting a temperature of the combined battery 81, a current detection resistor 87 with a high precision for detecting a discharging current value, a current detection portion 90, and a correction portion 91. Furthermore, in this case, in order to prevent heat generation by the current detection resistor 87 during discharging, the resistance value of the current detection resistor 87 needs to be decreased. Furthermore, the potential difference between terminals of the current detection resistor 87 is small, so that an amplifier 89 for amplifying the potential difference for calculating a current value is required.

Furthermore, in order to enhance the precision of calculation of a current value, it also is necessary to provide an offset voltage correction circuit 88 for correcting an offset voltage caused by variation of a circuit during amplification of the above potential difference. Because of this, the circuit scale of the conventional discharging control apparatus is large, resulting in a high cost.

### SUMMARY OF THE INVENTION

Therefore, with the foregoing in mind, it is an object of the present invention to provide a discharging control apparatus for a backup battery that can be configured at a low cost without inhibiting the prolonging of battery life.

In order to solve the above-mentioned problem, a discharging control apparatus for a backup battery of the present invention includes a discharging switch for turning on/off discharging to a load, a battery state detection portion of a combined battery, a remaining amount calculation portion for calculating a remaining amount obtained from the battery state detection portion, a subtraction portion, and a comparison portion. According to this configuration, in the case where the calculated capacity immediately after discharging is equal to or smaller than a previously set capacity, a discharging suspension signal is output. This can enhance the simplicity and inexpensiveness of the discharging control apparatus.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a configuration of a backup battery system in Example 1 of the present invention.

FIG. 2 is a block diagram showing a configuration of a backup battery system in Example 2 of the present invention.

FIG. 3 is a block diagram showing a configuration of a backup battery system in Example 3 of the present invention.

FIG. 4 shows a block configuration of a discharging control apparatus for a backup battery in a conventional example.

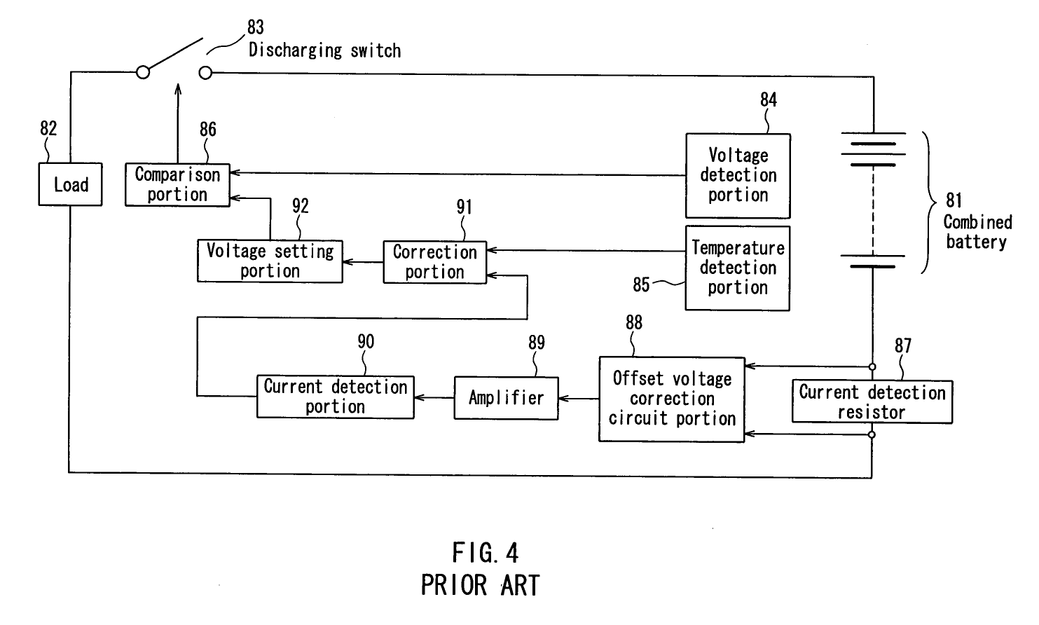

### DESCRIPTION OF THE PREFERRED EMBODIMENTS

A discharging control apparatus according to a first configuration of the present invention is used for a backup battery for backing up a main power source with at least one secondary battery. The apparatus includes a discharging switch for turning on/off discharging to a load, a state detection portion for detecting a state of the secondary battery, a remaining amount calculation portion for calculating a remaining capacity of the secondary battery based on data detected by the state detection portion, a discharging capacity setting portion for storing a discharging capacity estimated value during backup, a subtraction portion for subtracting the discharging capacity estimated value from the remaining capacity calculated by the remaining amount calculation portion, a remaining capacity setting portion for storing a remaining capacity lower limit value of the secondary battery at a completion of discharging, and a capacity comparison portion for comparing a subtraction result of the subtraction portion with the remaining capacity lower limit value, and outputting a discharging suspension signal for turning off the discharging switch, in the case where the remaining capacity lower limit value is equal to or larger than the subtraction result.

It is preferable that the state detection portion detects at least one of a full charging capacity value, a voltage value, a temperature, and a self-discharging amount. It is preferable that the remaining capacity lower limit value is set to be (1) a value smaller than that obtained by subtracting the discharging capacity estimated value from a capacity value for staring intermittent charging of the secondary battery; (2) a value smaller than that obtained by subtracting the discharging capacity estimated value from about 80% of a full charging capacity value; or (3) a value of 10 to 20% of a full charging capacity.

Furthermore, in the above-mentioned discharging control apparatus according to the first configuration, a discharging control apparatus according to a second configuration of the present invention includes a voltage detection portion for detecting a voltage of the secondary battery, a voltage setting portion for previously storing a predetermined voltage threshold value, and a voltage comparison portion for comparing the voltage detected by the voltage detection portion with the voltage threshold value, and outputting a discharging suspension signal for turning off the discharging switch, in a case where the voltage detected by the voltage detection portion is equal to or smaller than the voltage threshold value. It is preferable that the voltage threshold value is lower than a value estimated as a voltage of the secondary battery at a time when the capacity comparison portion outputs a discharging suspension signal.

It is preferable that the above-mentioned discharging control apparatus according to the first configuration includes a non-volatile memory for storing at least one of the discharging capacity estimated value and the remaining capacity lower limit value. This is because storage data can be kept even in the case where a power source voltage supplied to the discharging control apparatus is decreased due to the self-discharging or the like of a secondary battery.

It is preferable that the above-mentioned discharging control apparatus according to the second configuration includes a non-volatile memory for storing the voltage threshold value. This is because storage data can be kept even in the case where a power source voltage supplied to the discharging control apparatus is decreased due to the self-discharging or the like of a secondary battery.

Furthermore, the present invention can be carried out as a backup battery system provided with a backup battery for backing up a main power source with at least one secondary battery and a discharging control apparatus according to any one of the above-mentioned configurations.

By using the above-mentioned configuration, the remaining capacity immediately after the completion of discharging is presumed by subtracting the previously known discharging capacity during backup from the remaining capacity of a battery, and a discharging suspension signal is output in the case where the presumed remaining capacity is equal to or smaller than a remaining capacity lower limit value set so as not to inhibit the prolonging of the battery, whereby discharging can be suspended. Thus, a discharging control apparatus that can prolong battery life is provided at a low cost.

Hereinafter, the present invention will be described by way of examples with reference to the drawings.

### EXAMPLE 1

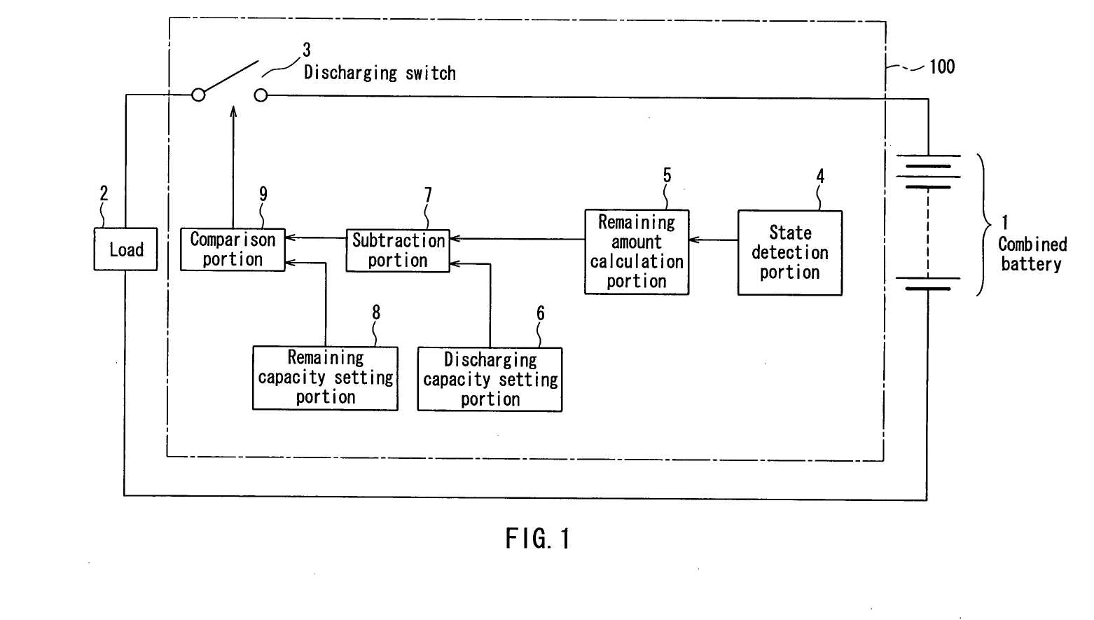

FIG. 1 is a block diagram showing a configuration of a backup battery system in Example 1 of the present invention.

As shown in FIG. 1, a backup battery system according to Example 1 includes a combined battery 1, a load 2, and a discharging control apparatus 100. The backup battery system is configured in such a manner that, when a commercial power source (main power source) is suspended, a discharging switch 3 is turned on with a discharging commencement signal from a control circuit (not shown in FIG. 1), and a current from the combined battery 1 is discharged to the load 2. Furthermore, the discharging control apparatus 100 has a function of preventing over-discharging of the combined battery 1 by sending a discharging suspension signal to the discharging switch 3 in the case where predetermined conditions (described later) are satisfied, after the discharging of the combined battery 1 is started.

In the discharging control apparatus 100, reference numeral 4 denotes a state detection portion, and 5 denotes a remaining amount calculation portion. The state detection portion 4 includes various kinds of sensors (not shown) for detecting data such as a full charging capacity value, a voltage value, a temperature, a self-discharging amount, and the like from the combined battery 1. The remaining amount calculation portion 5 calculates the remaining amount of the combined battery 1 based on the data obtained from the state detection portion 4.

The remaining amount of the combined battery 1 can be calculated, for example, by subtracting the self-discharging amount of the combined battery 1 from a time when charging is completed to a time immediately before the commencement of discharging, from the full charging capacity of the combined battery 1, and further subtracting a reduced capacity after the commencement of discharging from the full charging capacity with the self-discharging amount subtracted therefrom. The full charging capacity is determined by the kind of batteries constituting the combined battery 1. The self-discharging amount can be obtained from an elapsed time from the completion of charging to the commencement of charging and the temperature (measured by a temperature sensor) of the combined battery 1. The reduced capacity can be obtained from a change in voltage from the commencement of discharging. The method for calculating the remaining amount of the combined battery 1 is not limited to the above example.

Reference numeral 6 denotes a discharging capacity setting portion for giving a previously set discharging capacity value to a subtraction portion 7. Reference numeral 7 denotes a subtraction portion that subtracts the discharging capacity value given from the discharging capacity setting portion 6 from the remaining amount calculated by the remaining amount calculation portion 5. Reference numeral 8 denotes a capacity setting portion that gives the previously set capacity value to a comparison portion 9. The capacity value set in the capacity setting portion 8 represents a capacity to remain in the combined battery 1 at a completion of discharging so as not to allow the life of the combined battery 1 to decrease due to over-discharging.

Furthermore, the comparison portion 9 compares a calculation result of the subtraction portion 7 with the capacity value given from the capacity setting portion 8, and sends a discharging suspension signal to the discharging switch 3 in the case where a calculation result of the subtraction portion 7 is equal to or smaller than the capacity value set in the capacity setting portion 8. The discharging switch 3 is turned off when receiving a discharging suspension signal to suspend the discharging from the combined battery 1 to the load 2.

Hereinafter, the operation of the backup battery system will be described in detail.

The remaining amount of the combined battery 1 is calculated by the remaining amount calculation portion 5, using the data (fill charging capacity value, voltage value, temperature, self-discharging amount, etc.) detected by the state detection portion 4.

Generally, an apparatus to be backed up is configured so as to perform a predetermined operation upon receiving energy from a backup battery, in the case where a commercial power source is suspended. More specifically, in the case where the apparatus to be backed up is an information processing apparatus, when a commercial power source is suspended, the information processing apparatus detects the suspension and receives energy from the backup battery to perform data evacuation, apparatus shut-down processing, and the like. Furthermore, in these processings, a discharging pattern regarding how long a discharging current flows to what degree is determined previously. Thus, the discharging capacity during backup (during a discharging operation) can be presumed, and the discharging capacity value thus presumed (discharging capacity estimated value) is set previously in the discharging capacity setting portion 6. The subtraction portion 7 can find the remaining amount of the combined battery 1 immediately after the completion of backup (immediately after the completion of discharging) by subtracting the discharging capacity during discharging previously set in the discharging capacity setting portion 6 from the current capacity of the combined battery 1, as described above.

In the capacity setting portion 8, a capacity value to remain in the combined battery 1 is set previously at a completion of charging so as not to inhibit the prolonging of battery life. Such a capacity value preferably is set to be smaller than that obtained by subtracting the discharging capacity value set in the discharging capacity setting portion 6 from the capacity value for starting intermittent charging of the combined battery 1 (e.g., about 80% of a full charging capacity value). In general, it is preferable that the value of 10 to 20% of the full charging capacity is set in the capacity setting portion 8 as the capacity value.

The comparison portion 9 outputs a discharging suspension signal to the discharging switch 3, in the case where a calculation result obtained in the subtraction portion 7 is equal or smaller than the set capacity value given from the capacity setting portion 8. This can suspend the discharging from the combined battery 1 and prevent the life from being decreased due to the over-discharging of the combined battery 1, as described above.

### EXAMPLE 2

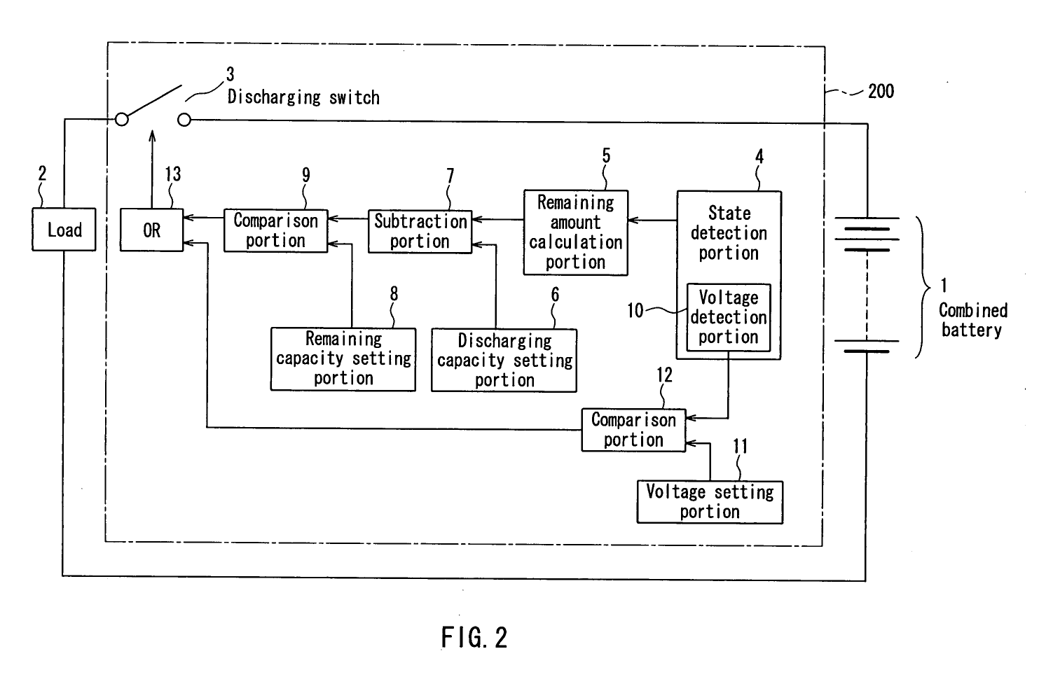

FIG. 2 is a block diagram showing a configuration of a backup battery system in Example 2 of the present invention.

In FIG. 2, the components having the same functions as those in Example 1 are denoted with the same reference numerals as those therein, and the description thereof will be omitted. In a discharging control apparatus 200 of Example 2, reference numeral 10 denotes a voltage detection portion for detecting a voltage of the combined battery 1. As described in Example 1, the sate detection portion 4 includes various kinds of sensors (not shown in FIG. 1) for detecting a full charging capacity value, a voltage value, a temperature, a self-charging amount, and the like. FIG. 2 shows only the voltage detection portion 10 that is a sensor for detecting a voltage, for simplicity of the description. Reference numeral 12 denotes a comparison portion that compares a detection voltage detected by the voltage detection portion 10 with a voltage threshold value previously set in a voltage setting portion 11. The comparison portion 12 outputs a discharging suspension signal in the case where the detection voltage is equal to or smaller than the voltage threshold value. Reference numeral 13 denotes an OR circuit that turns off the discharging switch 3 in the case where a discharging suspension signal is output from the comparison portion 9 or the comparison portion 12.

The capacity value in the capacity setting portion 8 and the voltage threshold value of the voltage setting portion 11 are set to be appropriate values so that the comparison portion 9 outputs a discharging suspension signal earlier than the comparison portion 12. More specifically, it is necessary for the voltage threshold value of the voltage setting portion 11 to be lower than a value estimated as a voltage of the combined battery 1 at a time when the comparison portion 9 outputs a discharging suspension signal. As described above, in the case where the capacity value (capacity to remain in the combined battery 1 at a completion of discharging) set in the capacity setting portion 8 is set to be 10 to 20% of the full charging capacity, the voltage threshold value set in the voltage setting portion 11 preferably is 0.95 V to 1.05 V per cell, in the case where the combined battery 1 is a nickel-hydrogen storage battery. If discharging is continued even when the voltage per cell reaches 0.95 V or less, the battery is likely to be in a deeply discharged state, and the internal pressure of the battery increases, resulting in a large decrease in battery life.

Thus, there is an advantage that, by setting the discharging suspension signal from the comparison portion 9 to be a main control signal and setting the discharging suspension signal from the comparison portion 12 to be a sub-control signal, the discharging control apparatus 200 does not require a configuration for temperature correction and discharging current value correction with respect to the set voltage value of the voltage setting portion 92 (correction portion 91, temperature detection portion 85, current detection portion 90, amplifier 89, voltage offset correction circuit 88, current detection resistor 87) that previously was required in a conventional example.

### EXAMPLE 3

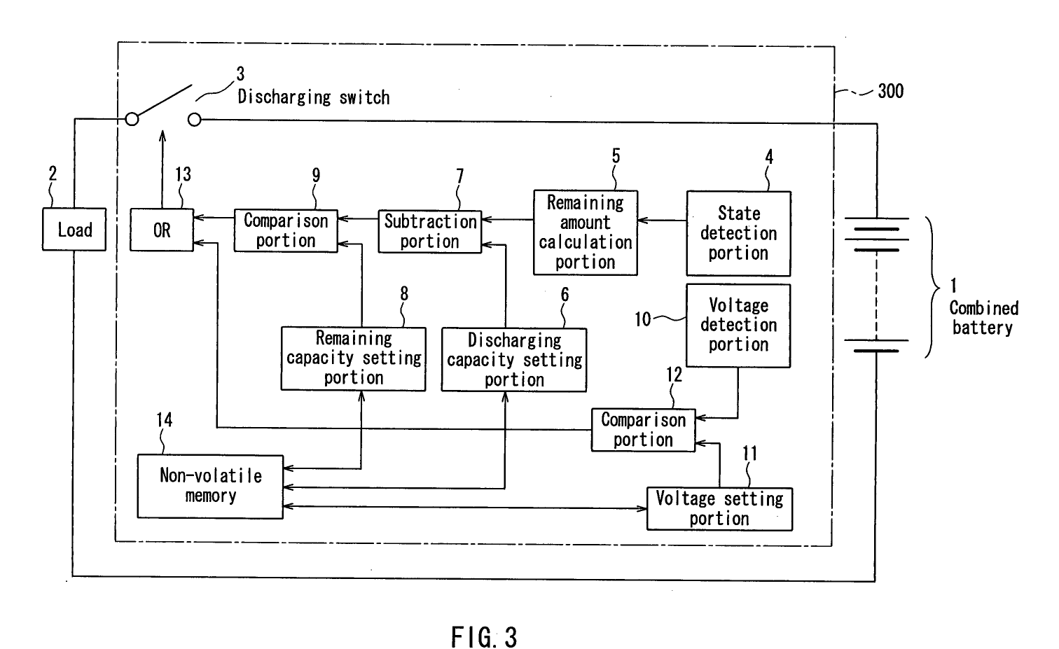

FIG. 3 is a block diagram showing a configuration of a backup battery system in Example 3 of the present invention.

In FIG. 3, the components denoted with the reference numerals 1 to 13 are the same as those in Examples 1 and 2, so that the description thereof will be omitted. In a discharging control apparatus 300 of Example 3, reference numeral 14 denotes a non-volatile memory.

The non-volatile memory 14 stores a discharging capacity value set in the discharging capacity setting portion 6, a capacity value input in the capacity setting portion 8, and a voltage value set in the voltage setting portion 11. Because of this, when a power source voltage supplied to the discharging control apparatus 300 decreases to suspend a circuit operation due to the self-discharging and the like caused by leaving a backup battery as it is for a long period of time, set data can be prevented from being lost.

In FIG. 3, the configuration in which the non-volatile memory 14 is added to the discharging control apparatus 200 of Example 2 has been illustrated. The configuration in which the non-volatile memory 14 is added to the discharging control apparatus 100 of Example 1 also is an example of the present invention.

Furthermore, in Example 3, the configuration in which the non-volatile memory 14 is added to the discharging control apparatus of Example 1 or 2 has been illustrated. It also is possible that the discharging capacity setting portion 6, the remaining amount setting portion 8, and the voltage setting portion 11 are composed of a non-volatile memory.

As described above, the discharging control apparatus according to Examples 1 to 3 obtains the remaining capacity of a backup battery immediately after discharging by calculation, and outputs a discharging suspension signal to suspend discharging when a calculation result is equal to or smaller than the set capacity value. Because of this, a simple and inexpensive discharging control apparatus can be configured without degrading life characteristics of a battery, and an excellent discharging control apparatus for a backup battery can be realized. Furthermore, the life of the backup battery can be prolonged.

Each of the above-mentioned examples does not limit the present invention and can be varied. For example, in Examples 1 to 3, a discharging control apparatus with respect to a backup battery provided with a combined battery in which a plurality of secondary batteries are connected in series has been disclosed. However, one secondary battery may be used as a backup battery.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A discharging control apparatus for a backup battery for backing up a main power source with at least one secondary battery, comprising:
a discharging switch for turning on/off discharging to a load;
a state detection portion for detecting a state of the secondary battery;
a remaining amount calculation portion for calculating a remaining capacity of the secondary battery based on data detected by the state detection portion:
a discharging capacity setting portion for storing a discharging capacity estimated value during backup;
a subtraction portion for subtracting the discharging capacity estimated value from the remaining capacity calculated by the remaining amount calculation portion;
a remaining capacity setting portion for storing a remaining capacity lower limit value of the secondary battery at a completion of discharging; and
a capacity comparison portion for comparing a subtraction result of the subtraction portion with the remaining capacity lower limit value, and outputting a discharging suspension signal for turning off the discharging switch, in the case where the remaining capacity lower limit value is equal to or larger than the subtraction result.

2. The discharging control apparatus according to claim 1, comprising:
a voltage detection portion for detecting a voltage of the secondary battery;
a voltage setting portion for previously storing a predetermined voltage threshold value; and
a voltage comparison portion for comparing the voltage detected by the voltage detection portion with the voltage threshold value, and outputting a discharging suspension signal for turning off the discharging switch, in a case where the voltage detected by the voltage detection portion is equal to or smaller than the voltage threshold value,
wherein the voltage threshold value is lower than a value estimated as a voltage of the secondary battery at a time when the capacity comparison portion outputs a discharging suspension signal.

3. The discharging control apparatus according to claim 1, comprising a non-volatile memory for storing at least one of the discharging capacity estimated value and the remaining capacity lower limit value.

4. The discharging control apparatus according to claim 2, comprising a non-volatile memory for storing the voltage threshold value.

5. The discharging control apparatus according to claim 1, wherein the state detection portion detects at least one of a full charging capacity value, a voltage value, a temperature, and a self-discharging amount.

6. The discharging control apparatus according to claim 1, wherein the remaining capacity lower limit value is smaller than a value obtained by subtracting the discharging capacity estimated value from a capacity value for staring intermittent charging of the secondary battery.

7. The discharging control apparatus according to claim 1, wherein the remaining capacity lower limit value is smaller than a value obtained by subtracting the discharging capacity estimated value from about 80% of a full charging capacity value.

8. The discharging control apparatus according to claim 1, wherein the remaining capacity lower limit value is 10 to 20% of a full charging capacity.

9. A backup battery system comprising a backup battery for backing up a main power source with at least one secondary battery, and a discharging control apparatus according to claim 1.

10. In a device comprising a backup battery for use when a main power source is interrupted, the improvement wherein the device comprises the battery backup system of claim 9.

11. The device of claim 10, which is in a form of an information processing apparatus.

12. The device of claim 10, which is in a form of an emergency lighting apparatus.
